(19) United States
(12) Patent Application Publication
(10) Pub. No.: US 2025/0384073 A1
(43) Pub. Date: Dec. 18, 2025

(54) SUMMARIZATION AND PRIORITIZATION OF DEVICE COMMUNICATIONS

(71) Applicant: Apple Inc., Cupertino, CA (US)

(72) Inventors: Erik M. BERGET, San Francisco, CA (US); Bryn BOWMAN, Lafayette, CA (US); David A. SCHAEFGEN, San Jose, CA (US); James BYUN, Los Angeles, CA (US); Justin S. TITI, San Jose, CA (US); Mateusz K. RAJCA, Menlo Park, CA (US); Rose G. MONTOYA, Cupertino, CA (US); Taylor G. CARRIGAN, San Francisco, CA (US); Vashishtha N. JOGI, San Jose, CA (US); Xiaohui TAO, Bellevue, WA (US); Yang ZHAO, Palo Alto, CA (US)

(21) Appl. No.: 19/180,046

(22) Filed: Apr. 15, 2025

Related U.S. Application Data
(60) Provisional application No. 63/647,074, filed on May 13, 2024.
(60) Provisional application No. 63/657,974, filed on Jun. 9, 2024.

(51) Int. Cl. G06F 16/34

(52) U.S. Cl. CPC G06F 16/345

(57) ABSTRACT

Aspects of the subject technology provide for receiving message items, mail items, voicemail items, and notification items, summarizing the items and providing the summary at a display according to each of the categorized summaries. Aspects of the subject technology further provide content classification of items and when an item is deemed to be important or urgent, a device mode can be provided or overridden to provide an interruption according to the item.

### CROSS REFERENCE TO RELATED APPLICATIONS

This application claims the benefit of U.S. Provisional Application No. 63/647,074, entitled “Summarization and Prioritization of Device Communications,” filed May 13, 2024, and U.S. Provisional Application No. 63/657,974, entitled “Summarization and Prioritization Of Device Communications,” filed Jun. 9, 2024, the entirety of which are incorporated herein by reference.

### TECHNICAL FIELD

The present description relates generally to electronic devices, including, for example, utilizing an electronic device to receive notifications, messages, mail, or voicemail, and summarizing and prioritizing such information.

### BACKGROUND

The advancement of technology has brought about increased features in communication applications which can lead to a more user-friendly experience or enjoyment of user devices.

### BRIEF DESCRIPTION OF THE DRAWINGS

Certain features of the subject technology are set forth in the appended claims. However, for purpose of explanation, several embodiments of the subject technology are set forth in the following figures.

FIG. 1 illustrates a diagram of various example electronic devices that may implement aspects of the subject technology in accordance with one or more implementations.

FIG. 2 illustrates a data flow diagram for data at a device implementing aspects of the subject technology, in accordance with one or more implementations.

FIG. 3 illustrates a flow diagram of an example system for providing images for selection to accompany a rich link, in accordance with one or more implementations.

FIG. 4 illustrates a table of input and output data for usage in summarizing content of communications and for determining if the communications are urgent or important, in accordance with some implementations.

FIGS. 5A, 5B, and 5C illustrate examples of a user interface at various implementations in providing summaries, in accordance with one or more implementations.

FIG. 6 illustrates a process flow for implementing aspects of the subject technology in accordance with some implementations.

FIG. 7 illustrates a process flow for implementing aspects of the subject technology in accordance with some implementations.

FIG. 8A illustrates an example electronic system with which aspects of the subject technology may be implemented in accordance with one or more implementations. FIGS. 8B and 8C illustrate flow diagrams for an application process implementing aspects of the disclosure, in accordance with some implementations. FIGS. 8D and 8E illustrate a device diagram and a system diagram, each of which implement aspects of the disclosure, in accordance with some implementations. FIGS. 8F and 8G illustrate a flow for an API calling module and API interface, which may be used in accordance with some implementations.

### DETAILED DESCRIPTION

The detailed description set forth below is intended as a description of various configurations of the subject technology and is not intended to represent the only configurations in which the subject technology can be practiced. The appended drawings are incorporated herein and constitute a part of the detailed description. The detailed description includes specific details for the purpose of providing a thorough understanding of the subject technology. However, the subject technology is not limited to the specific details set forth herein and can be practiced using one or more other implementations. In one or more implementations, structures and components are shown in block diagram form in order to avoid obscuring the concepts of the subject technology.

As described herein, content is automatically generated by one or more computers in response to a request to generate the content. The automatically-generated content is optionally generated on-device (e.g., generated at least in part by a computer system at which a request to generate the content is received) and/or generated off-device (e.g., generated at least in part by one or more nearby computers that are available via a local network or one or more computers that are available via the internet). To maintain data security, however, it may be desirable to generate the automatically generated content on-device, such as on a smartphone or tablet. In some implementations, the content can be shared with another user device, such as a companion device, such as a smartwatch device. This automatically-generated content may include visual content (e.g., images, graphics, and/or video), audio content, and/or text content. For example, the text content may include natural language output summarizing data taken from multiple sources, as described herein. The input data may include textual data, image data, or audio data, or any data from which words can be derived. In the case of image data, for example, a classification engine may provide information on text or objects depicted in an image and provide that information as an input to the summarization process. In the case of audio data, for example, a classification engine may provide information on words or sounds contained within the audio data and provide that information as an input to the summarization process.

In some embodiments, novel automatically-generated content that is generated via one or more artificial intelligence (AI) processes is referred to as generative content (e.g., generative images, generative graphics, generative video, generative audio, and/or generative text). Generative content is typically generated by an AI process based on a prompt that is provided to the AI process. An AI process typically uses one or more AI models to generate an output based on an input. An AI process optionally includes one or more pre-processing steps to adjust the input before it is used by the AI model to generate an output (e.g., adjustment to a user-provided prompt, creation of a system-generated prompt, and/or AI model selection). An AI process optionally includes one or more post-processing steps to adjust the output by the AI model (e.g., passing AI model output to a different AI model, upscaling, downscaling, cropping, formatting, and/or adding or removing metadata) before the output of the AI model used for other purposes such as being provided to a different software process for further processing or being presented (e.g., visually or audibly) to a user.

A prompt for generating generative content can include one or more of: one or more words (e.g., a natural language prompt that is written or spoken), one or more images, one or more drawings, and/or one or more videos. AI processes can include machine learning models including neural networks. Neural networks can include transformer-based deep neural networks such as large language models (LLMs). Generative pre-trained transformer models are a type of LLM that can be effective at generating novel generative content based on a prompt. Some AI processes use a prompt that includes text to generate either different generative text, generative audio content, and/or generative visual content. Some AI processes use a prompt that includes visual content and/or an audio content to generate generative text (e.g., a transcription of audio and/or a description of the visual content). Some multi-modal AI processes use a prompt that includes multiple types of content (e.g., text, images, audio, video, and/or other sensor data) to generate generative content. A prompt sometimes also includes values for one or more parameters indicating an importance of various parts of the prompt. Some prompts include a structured set of instructions that can be understood by an AI process that include phrasing, a specified style, relevant context (e.g., starting point content and/or one or more examples), and/or a role for the AI process.

Generative content is generally based on the prompt but is not deterministically selected from pre-generated content and is, instead, generated using the prompt as a starting point. In some embodiments, pre-existing content (e.g., audio, text, and/or visual content) is used as part of the prompt for creating generative content (e.g., the pre-existing content is used as a starting point for creating the generative content). For example, a prompt could request that a block of text be summarized or rewritten in a different tone, and the output would be generative text that is summarized or written in the different tone. Similarly a prompt could request that visual content be modified to include or exclude content specified by a prompt (e.g., removing an identified feature in the visual content, adding a feature to the visual content that is described in a prompt, changing a visual style of the visual content, and/or creating additional visual elements outside of a spatial or temporal boundary of the visual content that are based on the visual content). In some embodiments, a random or pseudo-random seed is used as part of the prompt for creating generative content (e.g., the random or pseudo-random seed content is used as a starting point for creating the generative content). For example, when generating an image from a diffusion model, a random noise pattern is iteratively denoised based on the prompt to generate an image that is based on the prompt. While specific types of AI processes have been described herein, it should be understood that a variety of different AI processes could be used to generate generative content based on a prompt.

Many people utilize handheld and other portable devices every day for their convenience and for sending and receiving messages from others. A device manufacturer and/or operating system provider of a device may provide a way for various messaging applications (including device developer supplied applications and third-party applications) the ability to trigger a notification to the device when a message is received through the application. Thus, when a message is received by a user, the messaging application may provide a notification on the device that a new message has been received. The notification may include some information about the new message, such as the time received, the sender, the subject of the message (if applicable), and a snippet from the message.

While a user is away from their device or while a user's device settings are suppressing notifications, notifications from the various applications may continue to be received. Taking the device lock screen as an example, each of the notifications may be collected, organized, and stacked on the lock screen into stacked graphical user interface elements (e.g., “cards”) with the notification information. Security settings of the device may allow a user to view the notifications while the device is locked (or prior to navigating away from an unlocked lock screen) by selecting a stacked card, which then can expand into each individual card to allow the user to visually look through the cards and/or select a card which can then link the user straight to the associated message of the associated application. Notifications may be related to any type of application installed on the device that provides notifications for display to the user. In many instances, the notifications may be triggered by some outside data which is provided to the device, such as the status of a contact in a location application, or the status of a food order. In some instances, the notifications may be provided by the application without outside data, such as a reminder to open an application for the day, a reminder to check a news feed, a reminder for events that come from a locally stored calendar, and so forth.

A first aspect of the subject technology provides at a notifications output display, in addition to stacked cards, a top-level summary card which summarizes all the notifications which have not yet been seen. The cards can be grouped by application or by application type. Likewise, the summary can be of just the group of cards underlying the summary card. Thus, one summary card may include information from one application or from multiple different applications, depending on how the groups of cards are collected and/or organized.

Another aspect of the subject technology provides, for a text messaging application, summary information for conversations. A thread screen for example, can show an organized view of the available ongoing conversations, with more recent activity organized toward the top. Rather than show, in the conversation view, the content or a snippet of content from the last received message with that person or group, a summary of the recently received messages or a summary of unread messages with that person or in that group may be shown.

Another aspect of the subject technology provides, for an email application, summary information for email messages. An inbox screen of an email application, for example, can show an organized view of the recently received emails, with the most recent emails organized toward the top. The inbox screen may typically show a sender tag, a subject line, a time stamp, and a snippet or message preview of the corresponding message. Rather than show, in the inbox screen, the snippet or message preview of the message, a summary of the message may be provided. This aspect may also allow a user to trigger a manual summary of an email.

Another aspect of the subject technology provides, for a voicemail application, summary information for voicemails. When a device provides a transcript of a voicemail, the transcript can be provided to the summarization framework and a summary of the voicemail can be provided at a top level list of voicemails.

Another aspect of the subject technology provides, in addition to summaries in the above-noted different modalities, content-aware parsing so that the system can determine, while creating the summaries, that a particular message is urgent. Urgent messages can be provided in a designated area of the lock screen, message interface, and/or email interface to call attention to the user to the urgent message.

Another aspect of the subject technology provides a device mode that will limit notifications in a content-aware manner. Other device modes, for example, may provide the ability for a user to set notification options relating to specific applications or contacts to suppress or allow certain types of notifications. The device mode provided by the subject technology, however, provides the ability to generally suppress all notifications unless the corresponding message is determined to be urgent or important. The subject technology can also provide a setting for each of the other device modes to allow for intelligent break through of the device mode settings of urgent notifications regardless of at least some of the other notifications settings associated with that device mode. For example, if a contact or number is placed on a do not notify list that contact or number may not be able to break through the setting even if a message from that contact or number is determined to be urgent. However, if a contact or number is not specifically blocked, but notifications in general are suppressed, then an urgent message may be able to intelligently break through the suppressed notification setting and provide a notification on the device.

Therefore, the subject technology advantageously provides a technological solution for providing summaries of notifications, messages, and emails, as well as analyzing a notification, message, or email to determine whether it is urgent or important for overriding a device mode setting limiting interruptions. The subject technology advantageously reduces time, processing resources, memory resources, and/or battery resources by providing summaries of items to users, to reduce an overall time accessing a user device. Further, the subject technology provides a technical solution for increasing productivity and usefulness of a user device.

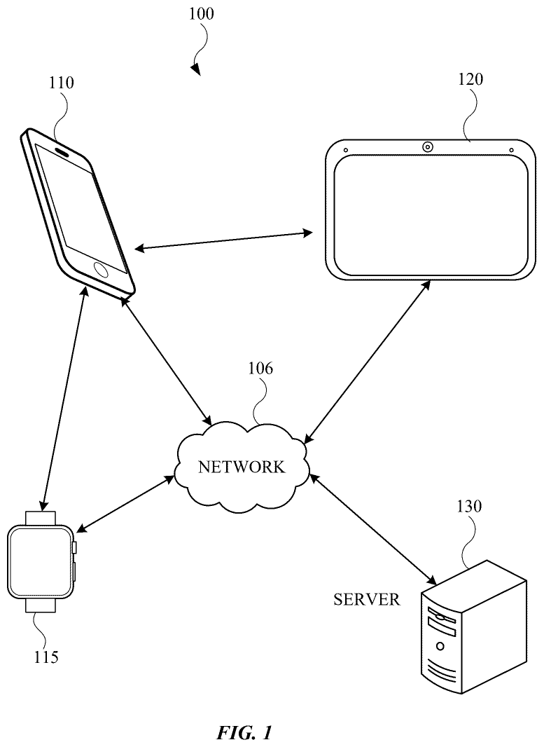

FIG. 1 illustrates an example network environment 100 in accordance with one or more implementations. Not all of the depicted components may be used in all implementations, however, and one or more implementations may include additional or different components than those shown in the figure. Variations in the arrangement and type of the components may be made without departing from the spirit or scope of the claims as set forth herein. Additional components, different components, or fewer components may be provided.

The network environment 100 includes an electronic device 110, an electronic device 115, an electronic device 120, and a server 130. The network 106 may communicatively (directly or indirectly) couple the electronic devices 110-120 and/or the server 130. In one or more implementations, the network 106 may be an interconnected network of devices that may include, or may be communicatively coupled to, the Internet. For explanatory purposes, the network environment 100 is illustrated in FIG. 1 as including the electronic device 110, the electronic device 115, the electronic device 120, and the server 130; however, the network environment 100 may include any number of electronic devices and any number of servers or a data center including multiple servers. In some implementations one or more of the electronic devices 110-120 may not be connected to the network 106, but may be tethered to one of the other electronic devices 110-120 wirelessly or by a wired connection.

Each of the electronic devices 110-120 may be, for example, a desktop computer, a portable computing device such as a laptop computer, a smartphone, a peripheral device (e.g., a digital camera, headphones), a tablet device, a wearable device such as a watch, head mounted display, and the like. In FIG. 1, by way of example, the electronic device 110 is depicted as a mobile electronic device (e.g., smartphone), the electronic device 115 is depicted as a smartwatch, and the electronic device 120 is depicted as a tablet computer. The electronic device 110, the electronic device 115, and the electronic device 120 may be, and/or may include all or part of, the electronic system discussed below with respect to FIG. 9.

In one or more implementations, one or more of the electronic devices 110-120 may provide a system process that handles or facilitates the handling of emails, messages, and/or application notifications. These items can be indexed for their content, submitted to a summarizing process, and then a summary of the items can be provided. In one or more implementations, operations that involve individually identifiable information of a user of one or more of the electronic devices 110-120 may be performed securely or use encryption on the electronic devices 110-120, to prevent exposure of individually identifiable data to devices and/or systems that are not authorized by the user. Privacy being an important consideration, the summarizing process may be located on one or more of the electronic devices 110-120 and not, for example, the server 130, so that the summarizing actions take place locally, or within the same local network. In one or more implementations, one electronic device 110-120 may perform the summarizing and provide the summary information to another of the electronic devices 110-120. For example, in the case where the summarizing device is a smartphone, the summaries may be provided to a companion device of the smartphone user, such as a smartwatch or tablet device.

The server 130 may form all or part of a network of computers or a group of servers, such as in a cloud computing or data center implementation. For example, the server 130 stores data and software, and includes specific hardware (e.g., processors, graphics processors and other specialized or custom processors) for rendering and generating content such as graphics, images, video, audio and multimedia files. In an implementation, the server 130 may function as a server corresponding to one or more applications installed on the electronic devices 110-120 that transmits data to the electronic devices 110-120 for use in the corresponding application, such data including messages, email, or other informational content generated by the above-discussed electronic devices 110-120 and/or the server 130 to another of the above-discussed electronic devices 110-120.

In the example of FIG. 1, each of the electronic devices 110-120 are depicted as a particular type of device, e.g., smartphone, smartwatch, tablet. However, it is appreciated that each of the electronic devices 110-120 may be implemented as another type of device, such as a wearable device (e.g., a smartwatch or other wearable device). The electronic devices 110-120 may be a device of a user (e.g., the electronic devices 110-120 may be associated with and/or logged into a user account for the user at a server).

Each of the electronic devices 110-120, may include a body or housing containing elements such as input interfaces, output interfaces, processors, displays, processor(s), storage, system memory, read-only memory, network interfaces, and so forth, such as depicted in the electronic system discussed below with respect to FIG. 9.

To the extent that a single electronic device 110 is referenced herein, for the sake of simplicity, it is appreciated that any of the electronic devices of FIG. 1 may be utilized.

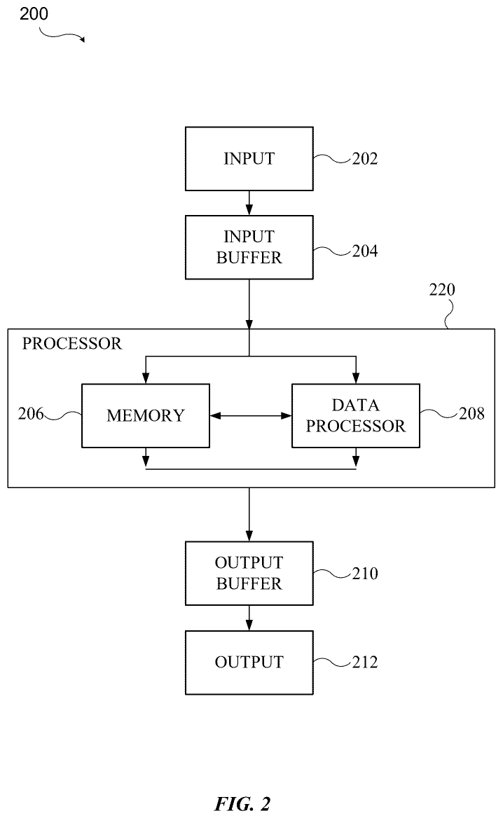

FIG. 2 illustrates data flow 200 in a device used for processing data in accordance with one or more implementations. Typical processing of data (e.g., at the electronic device 110) begins when the data is received at an input 202 and processed into an input buffer 204. The data is then transferred to a processor 220, where it is processed, and output to the output 212.

The processor 220 may include a memory 206 and a data processor 208. Depending on specific implementations, the processor 220 may also include other processors such as, for example, a graphics processor (which is not explicitly shown in FIG. 2). Thus, based on the type of device, the data processor 208 may perform, among other things, compression and/or decompression of the received data, encrypt the received data for storage, modulate or demodulate the received data, and/or perform other data manipulation.

In some implementations, each of the electronic devices 110, 115, and 120, and server 130 can include the data flow of FIG. 2. In some implementations such as a smartwatch or other secondary device, processing power, memory, and/or battery constraints may make it so that it is preferred for data processing of the message (e.g., indexing and summarization of data) to be performed on another device, such as the electronic device 110, for example, by sending or receiving messages through the electronic device 110 to the server 130. A summary, once produced at the electronic device 110 may be provided to the secondary device for inclusion in the notifications, messaging, or mail information therein.

In some implementations, because of the environment in which the electronic devices functions, the processor 220 may have limited processing resources and/or storage resources outside the processor 220 may be limited. Processing resources can include a processing unit (e.g., CPU), FPGA, ASIC, hardware electronic circuit, etc. For example, in some implementations, thousands of instances of data processing (e.g., indexing and data summarization) may need to be performed at the same time within given memory constraints. In some implementations, the processing resources of the processor 220 include a memory 206 which may be used as a cache or to provide a data buffer for certain data processing algorithms. Storage resources outside the processing resources may include other volatile or non-volatile memory.

For example, in some implementations, while processing the received data, the data processor 208 may store some or all of received data, processed data and/or intermediate data in memory 206. The memory 206 may include RAM, ROM, and/or non-volatile memory.

Upon or during the processing of the data, the data processor 208 may write the processed data to the memory 206 and/or to an output buffer 210.

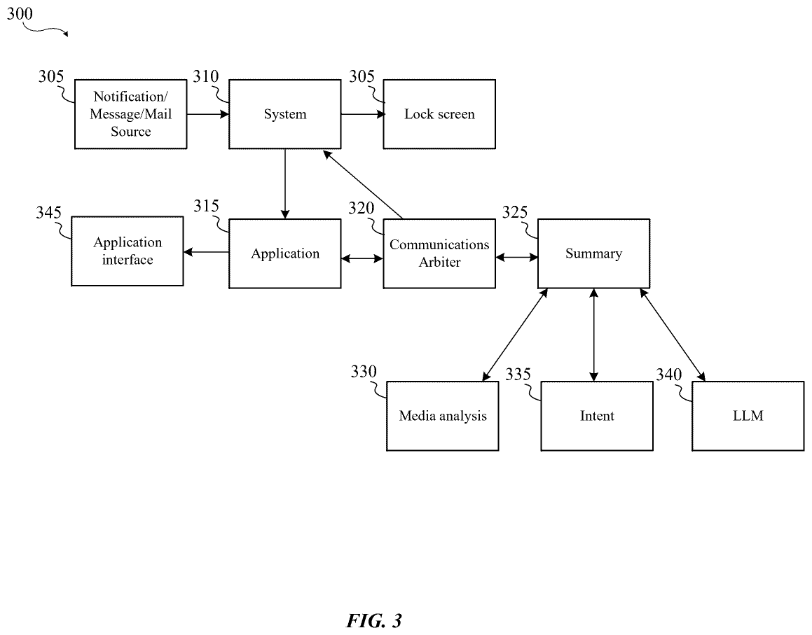

FIG. 3 illustrates a data flow diagram 300 for an example system for indexing, summarizing, and categorizing message, mail, and notification data, in accordance with some implementations. One or more blocks (or operations) of the flow diagram of FIG. 3 may be performed by one or more other components and other suitable devices. Further for explanatory purposes, the blocks are described herein as occurring in serial, or linearly. However, multiple blocks of the process may occur in parallel. In addition, the blocks of the process need not be performed in the order shown and/or one or more blocks of the process need not be performed and/or can be replaced by other operations.

At block 305, a user device may receive data from an outside the device source, e.g., a server, such as the server 130. The data may correspond, for example, a push or pull data to or from an application installed on the device. The data may, for example, further correspond to a notification, a message (such as a text message), an email, or a voicemail.

At block 310, the data is provided to a system process running on the device. The system process can determine which application the data corresponds to and, at block 315, forward the data to the specific application which corresponds to the data. For example, a text message for a messaging application may be forwarded to the messaging application. A chat message for a third-party chat application installed on the device may be forwarded to the third-party chat application. In another example, an email message may be forwarded to a mail application installed on the device. For some data, such as message data for a messaging application provided by the device manufacturer, email data for an email application provided by the device manufacturer, or voicemail data for a voicemail application provided by the device manufacturer, the data can also be forwarded by the system process at block 310 directly to the communications arbiter at block 320. Data can further include image or audio information from which text, for example, can be obtained.

At block 320, the application at block 315 can provide a notification item based on the data received to the communications arbiter. The communications arbiter is generally responsible for processing notification requests from applications to provide the notification requests to a notifications display, such as a notifications display located on the lockscreen of the device. Thus, generally, the notification information from the applications is routed through the communications arbiter. In addition to the notification information from the applications, including from third-party applications, messages, mail items, and voicemail items may be routed through the communications arbiter. Thus, the communications arbiter receives at block 320 notification data, message data, mail data, and voicemail data. In addition, the communications arbiter may receive (as noted above, at the block 310 from the system process, or from the application process at the block 315) notification data that also corresponds to message data, mail data, and/or voicemail data. For example, the mail application can provide a notification request to the communications arbiter in addition to the actual mail item related to the notification request. Similarly, the message application can provide a notification request to the communications arbiter in addition to the message item related to the notification request. Also similarly, the voicemail application can provide a notification request to the communications arbiter in addition to the voicemail item related to the notification request.

In aspects of the subject technology, the communications arbiter can initiate a process to summarize the notification information, mail information, message information, and voicemail information. In order to provide time for the notifications to be summarized, the notifications can be held for a time period by the communications arbiter, for example, between about 1 second and 20 seconds, such as about 5-10 seconds. After the hold time, the notifications can be passed back to a system process at block 310 for providing to the lock screen at block 305.

The communications arbiter can index the notification information, mail information, message information, and voicemail information and then send the notification information, mail information, message information, and voicemail information to a summary process at block 325. When two of the items for summarization overlap in content, for example, a mail item is included both as the mail item and as a notification corresponding to the mail item, only one copy of the data, e.g., the mail item, is sent to the summary process at block 325. This deduplication of content reduces the number of summaries needed to be generated.

At block 325, the summary process can utilize various resources to generate a summary of the item. The summary process can send the notification information, mail information, message information, and voicemail information to a media analysis process at block 330 when the information contains media, such as a photo, video, or audio file is provided as part of the information. The summary process can send the notification information, mail information, message information, and voicemail information to an intent process at block 335 to determine whether the content of the notification information, mail information, message information, or voicemail information, is deemed to be important or urgent. The summary process can send the notification information, mail information, message information, and voicemail information to a LLM model at block 340 to perform the summarization of the content of the item. Each of the blocks 330, 335, and 340 can return responses back to the summary process at block 325. The summary process block 325 can return the responses back to the communications arbiter at block 320. The communications arbiter can provide summary information to the application at block 315 for summary information related to content of the application, e.g., mail items, message items, and voicemail items. The application can provide the summary information to a display interface of the application at block 345 to display the summarized information. Returning to the communications arbiter at block 320 after receiving the summary information from the summary process at block 325, the communications arbiter can provide the summary information for notification summaries to the system at block 310 which can then provide the summary information to include as a summary platter on top of the notifications in the lock screen at the block 305, in accordance with some implementations. In other implementations, the system can provide the summary as a notification displayed in a banner style at the top of the screen.

Returning to the media analysis process at block 330, the media analysis can be performed using any suitable media analysis and classification technique. For example, the media can be submitted to one or more machine learning models trained for classification and/or object detection of the media item. In return, a brief textual description can be provided of the media item.

Returning to the intent process at block 335, intent can be determined to categorize the item as being urgent or important by a confluence of various considerations. Both the content and the context of the data item can be examined to determine if the item is urgent or important. Further, how the user interacts with their device over time can be used to inform whether a message should be marked urgent or important. For example, the time that the user devotes to notification engagement may be considered. The time that the user typically takes to resolve a notification from the time of reception to the time of engagement and resolution may be considered. Which applications are launched via the notification interface (top of screen interruption banner or lock screen) may be considered. Which applications are launched in one context (e.g., lock screen) versus another context (e.g., banner notification). Additional considerations may include any known or derived relationship with sender (e.g., friend, contact, family, emergency contact, VIP mail, pinned person, known sender (FIA)); any interactions with the sender (e.g., recently interacted with). Other considerations for context may include an application category associated with the potential notification interruption, such as application category (e.g., entertainment, social, productive); application usage; time (e.g., week day, weekend, time of day); location. These contextual items in addition to the content of the notification may be used as training data for an MLM to generate a prediction that the message is urgent or important. When urgent or important, delivery of the notification may be configured to break through a focus or device mode which would have otherwise suppressed the triggering of the notification.

Returning to the LLM process at block 340, a large language model (LLM) or another mechanism can be used to summarize the item. The LLM can take as input, the data and/or a description of the data, for example, resulting from the media analysis process at block 330. The LLM can be implemented by any suitable LLM scheme and may be localized to the device, such as the electronic device 110.

The summary process at block 325 can utilize pre-filtering to enhance processing of items. For example, when the mail application sends mail items to the communication arbiter, the mail application can also send data indicating information about the mail item. For example, a category determination with respect to whether the mail item is a personal email item, whether the mail item is spam, whether the item is related to two-factor authentication, whether the time is new or a backlogged item, whether the item is marked by the application as being from a priority contact, whether the item is flagged by the sender, or whether the item is read or unread. This information can be used to determine whether the summarization will take place, by making a determination as to whether it is a duplicate item, whether the item is outside a time threshold (e.g., too old), whether the items is from a known contact with a previous interaction, whether in an address book, or whether the item can be summarized within a power budget (e.g., too long and/or too short).

Pre-filtering on message items can include a determination with respect to whether the message is marked as spam, whether the message relates to two-factor authentication, whether the message is a new item or a backlog item, whether the item is from a pinned conversation, or whether the item is read or unread. This information can be used to determine whether the summarization will take place, by making a determination as to whether it is a duplicate item, whether the item is outside a time threshold (e.g., too old), whether the items is from a known contact with a previous interaction, whether in an address book, or whether the item can be summarized within a power budget (e.g., too long and/or too short).

Pre-filtering on notifications can include any information provided by the application requesting the notification, such as information provided with the notification request from a third-party application. Such information could be any of the information previously discussed, for example, when an application programming interface is provided for the third-party apps to provide such information. This information can be used to determine whether the summarization will take place, by making a determination as to whether it is a duplicate item, whether the item is outside a time threshold (e.g., too old), whether the items is from a known contact with a previous interaction, whether in an address book, or whether the item can be summarized within a power budget (e.g., too long and/or too short).

Pre-filtering on voicemail can include any information indicating with respect to the voicemail item whether the item is spam, whether the item has good audio or transcript quality, whether the item is new, whether the item is from a known contact, and so forth. This information can be used to determine whether the summarization will take place, by making a determination as to whether it is a duplicate item, whether the item is outside a time threshold (e.g., too old), whether the items is from a known contact with a previous interaction, whether in an address book, or whether the item can be summarized within a power budget (e.g., too long and/or too short).

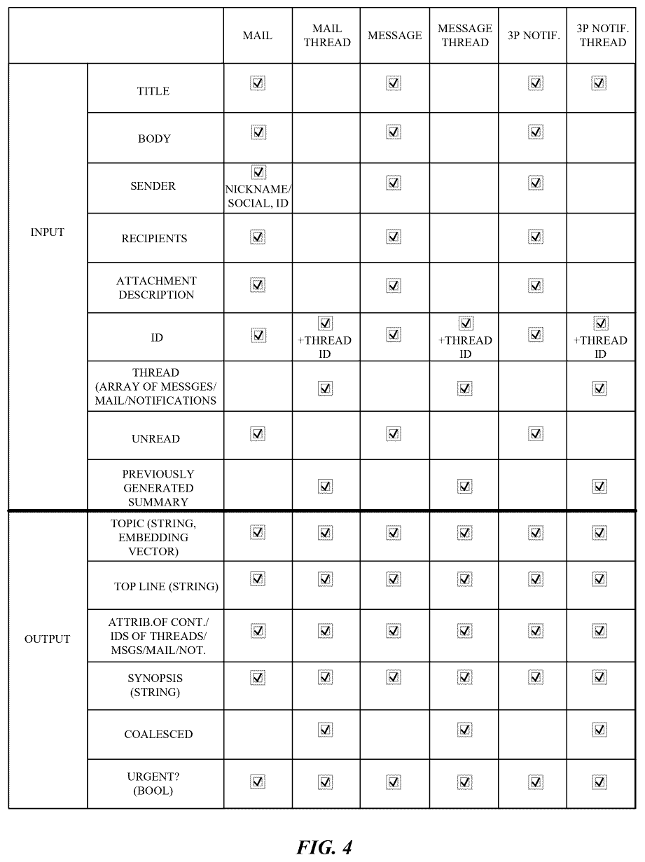

The summary process at block 325 can provide summary information such as topic, top line information, attribution of content (such as names or ids of source of content), a synopsis of the content, whether the summary is coalesced from multiple items in a thread, whether the item is urgent or important. A table is provided in FIG. 4 of inputs and outputs of the summary process at block 325. It should be appreciated that the table is non-exhaustive and additional data points can be provided as inputs and additional data summaries can be provided as outputs. The table in FIG. 4 provides inputs to the summarization processes of the subject technology as rows in the upper part of the table. The columns correspond to application content types that can use the summarization processes of the subject technology, including, for example, an email application for summarizing mail items utilizing data from title, body, sender, recipients, attachment descriptions, identifier, and read/unread status. A mail thread (e.g., of a mail conversation) can utilize an identifier (e.g., of the thread), content of the thread, and a previously generated summary (e.g., generated as a mail item). Messages and notifications (including third-party notifications) can use content items as inputs which are similar to mail items and message threads and notification threads (including third-party notification threads) can utilize items similar to those used in mail threads.

The output of the summary process at block 325, as illustrated in the table of FIG. 4, can provide topic summarization information, top line summarization information, summarization information surrounding attributes of content and/or ids of each of the summarized items, a synopsis summarization information, and/or a determination that the summarized message, notification, or mail item (or corresponding threads) are urgent. It should be understood that each input

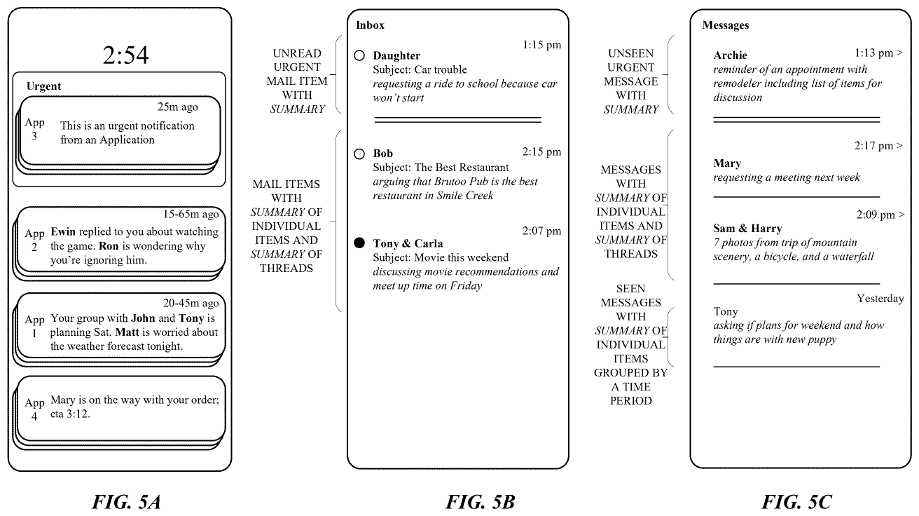

FIGS. 5A, 5B, and 5C illustrate example interfaces which demonstrate a visual representation of the resulting summarization such as discussed above with respect to the data flow diagram 300 of FIG. 3, in accordance with some embodiments. FIGS. 5A, 5B, and 5C each illustrate an interface of a notification screen, a mail application, and a messaging application, respectively, in accordance with some embodiments. It is appreciated that the drawings of FIGS. 5A, 5B, and 5C and do not include all the features discussed and may include other features and elements which are not provided for the sake of simplicity.

FIG. 5A illustrates a lock screen of a device. The lock screen includes notifications which have been processed. The notifications are grouped, in this case, by application. A summary platter of each group of notifications is provided on top of each grouped collection of notification platters. When a user selects the summary notification, the view of the notifications can be expanded, and each of the underlying notifications can be revealed in a list of platters. A user can dismiss the list of notifications or select an individual notification to be taken to the corresponding application and item in that application related to that notification. FIG. 5A further illustrates that notifications can come from any application that provides notifications to the system for display in a notification interface (such as at the lock screen as illustrated) or as a notification displayed as a banner at the top of the screen.

An area of the display is reserved for urgent notifications. The urgent notifications from different applications can be stacked together, with the most urgent or most recent urgent notification positioned on top of the other urgent notifications. In some implementations, a summary of urgent notifications can be provided in a summary platter on top of the urgent notifications.

FIG. 5B illustrates a mail interface of a mail application running on a device. The mail application includes several email items in the inbox of the mail application. A portion of the interface includes an area where unread urgent mail items are included. As illustrated in FIG. 5B, this item is summarized, but it should be appreciated that urgent items may not be summarized. Another portion of the interface includes a list of read and unread items (the solid circle indicating read, the empty circle indicating unread). The email items may each optionally include a subject line (or a portion thereof). A summary of the email or an email thread may be provided below the sender. An email thread with multiple items can include a summary of the multiple items in the thread. In such cases, the summary may be expanded to be able to accommodate a greater amount of summary data. In some implementations, when a mail item is read, the summary information may be removed, while in others it may remain for a read mail item. In some implementations, the mail application can also provide the ability to select an option to summarize a mail item. For example, if the user opens a mail item where no summary is provided, the user can select an input to indicate that the mail item should be summarized. The mail item can be sent to a communications arbiter, for example, at block 320 described above, which arranges the summary, such as described above.

The area of the display for urgent mail items may be able to be expanded to accommodate multiple urgent or important emails. It is noted that the determination of an urgent or important email is not based solely on an indicator sent with the message, for example, as marked by a sender of the email, but such an indicator may be considered in the local determination that the email is urgent or important.

FIG. 5C illustrates a message interface of a message application running on a device. The message application includes several conversation threads in the interface. A portion of the interface may include an area where unread urgent messages are included. Selection of the message summary may open the messaging item, displaying a conversation with the person or group members relating to the messaging thread. A summary for each of the unread message items may be combined into the summary displayed in FIG. 5C. Once a message has been seen, read, or opened, in some implementations, the summary may be replaced with an excerpt of the last received message in the conversation. In other implementations, the most recent summary may remain until a new message is received in the conversation, at which point the summary may be replaced with a new summary.

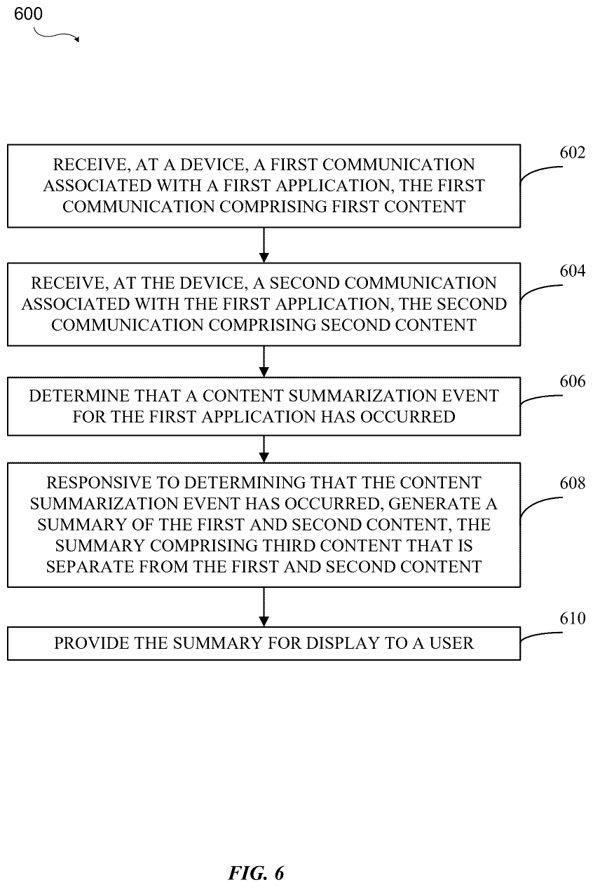

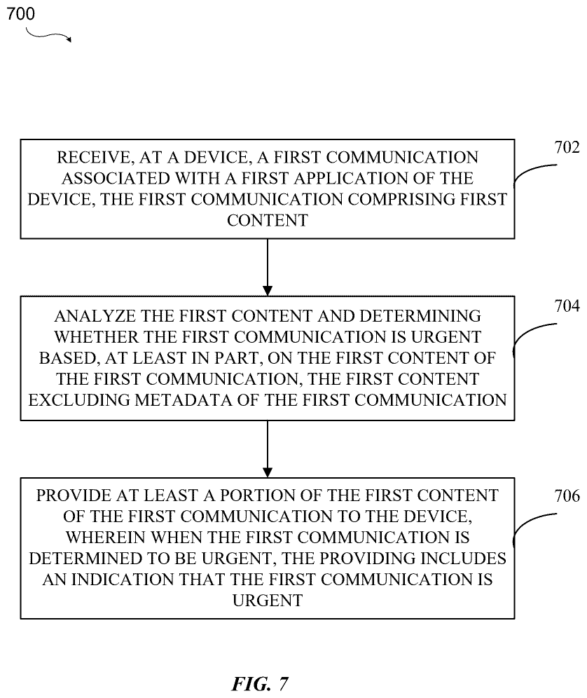

FIG. 6 illustrates a flow of an example process 600 for providing a summary of content related to a notification, a message, an email, or a voicemail, in accordance with some embodiments. One or more blocks (or operations) of the process flow diagram of FIG. 6 may be performed by one or more other components and other suitable devices. Further for explanatory purposes, the blocks are described herein as occurring in serial, or linearly. However, multiple blocks of the process may occur in parallel. In addition, the blocks of the process need not be performed in the order shown and/or one or more blocks of the process need not be performed and/or can be replaced by other operations.

At block 602, the process 600 may include receiving, at a device, a first communication associated with a first application of a plurality of applications, the first communication having first content. For example, a first communication can include a notification, message, email, or voicemail received at the device, such as described above with respect to block 305.

At block 604, the process 600 may include receiving, at the device, a second communication associated with at least one of the plurality of applications, the second communication having second content. For example, a second communication can include a second notification, message, email, or voicemail received at the device, such as described above with respect to block 305.

At block 606, the process 600 may include determining that a content summarization event for at least one of the plurality of applications has occurred. For example, after the communications arbiter submits communications to the summary process at block 325, the communications arbiter can receive a summary back from the summary process.

At block 608, the process 600 may include responsive to determining that the content summarization event has occurred, generating a summary of the first and second content, the summary having third content that is separate from the first and second content. The summary, for example, can include summary information for the first communication and the second communication received from the summary process at block 325.

At block 610, the process 600 may include providing the summary for display to a user. For example, when the summary is for a notification, the summary may be provided as a platter on top of other notifications on the lock screen (e.g., where notifications are displayed). When the summary is for a message, an email, or a voicemail, the summary may be provided by the corresponding application.

These processes also contemplate providing, for example, by an application programming interface (API) the ability for a third-party application to submit data to the communications arbiter (or a like process dedicated for third-party applications), generate a summary using the processes described herein, and return via the API back to the third-party application the summary information that the third-party application can then use in the display of the application.

In some implementations, the content summarization event may occur based on at least one of: a user request for the summary, an amount of time elapsed from receiving the first communication without detecting that the first content was viewed by the user, or a number of received communications associated with the at least one of the plurality of applications. The process 600 may also include providing the summary for display in the first application associated with the first and second communications, or providing the summary for display on a lock screen of the device in association with a first excerpt of the first communication and a second excerpt of the second communication. In some implementations, the third content of the summary is distinct from the first and second excerpts. In some implementations, the summary is displayed in a first graphical element, the first excerpt is displayed in a second graphical element, and the second excerpt is displayed in a third graphical element, where the first, second and third graphical elements are displayed in a stack with the first graphical element being displayed as a top of the stack. In some implementations, generating the summary comprises providing the first content, the second content, and parameters as a prompt to a machine learning model, such as a large language model, and receiving the summary according to the prompt provided to the machine learning model and may also include determining that the summary satisfies the parameters supplied to the machine learning model. The machine learning model can return generative content including the summary. Thus, embodiments can include a machine learning model as discussed herein as an automatic summary generating process.

In some implementations, while the device is locked, one or more additional communications corresponding to at least one of the plurality of applications may be received. Updating the summary may further be based on the one or more additional communications, where the summary is provided on a lock screen of the device or in the corresponding first application.

In some implementations, the process 600 can include the method further comprises: receiving a third communication related to a second application, where the third communication is similar to at least one of the first communication or the second communication; and determining the similarity of the first communication, the second communication, and the third communication; forgo generating a second summary based on the third communication. In such implementation, when similar information is provided through different communications channels, a process to generate a second summary can be omitted. Similar information may be determined by analyzing the information for content similarity. Similar information may instead or in addition include information within the same threaded program stack as the previously received information.

In some implementations, the process 600 may further include generating a second summary of third content associated with a third communication, where the third communication is associated with at least one of the plurality of applications; and providing the second summary for display to the user, where the second summary includes a summary of the first content, the second content, and the third content. In some implementations, when another notification, message, or mail item is received and some prior communications and their associated summary have not been read or accessed, the first summary can be replaced with a second summary that includes a summary of all the unread notifications, mail items, message items, and voicemails.

FIG. 7 illustrates a flow of an example process 700 for determining whether a notification, message, email, or voicemail is urgent and providing a notification or indication of the urgency of the notification, message, email, or voicemail, in accordance with some embodiments. One or more blocks (or operations) of the process flow diagram of FIG. 7 may be performed by one or more other components and other suitable devices. Further for explanatory purposes, the blocks are described herein as occurring in serial, or linearly. However, multiple blocks of the process may occur in parallel. In addition, the blocks of the process need not be performed in the order shown and/or one or more blocks of the process need not be performed and/or can be replaced by other operations.

At block 702, the process 700 may include receiving, at a device, a first communication associated with a first application of the device, the first communication comprising a first body of text and metadata. The device may include an electronic device such as the electronic device 110. The communication may correspond to a notification, a message, an email, or a voicemail received at the device, such as described above with respect to block 305. The notification may be received, for example, by a third-party application installed on the device.

At block 704, the process 700 may include analyzing the first body of text and determining whether the first communication is urgent based, at least in part, on the first body of text independently of the metadata. The content of the communication (e.g., the notification, message, email, or voicemail) may be analyzed to determine its urgency, such as described with respect to block 335. The first content which is analyzed may include at least data that is exclusive of metadata associated with the communication.

At block 706, the process 700 may include providing at least a portion of the first body of text of the first communication to the device, where when the first communication is determined to be urgent, the providing includes an indication that the first communication is urgent. When the communication is determined to be urgent, then an indication can be provided in the application, such as a messaging application, an email application, a voicemail application, or a notification displaying application, that the communication is urgent.

In some implementations, the metadata associated with the first communication may also be considered and the metadata may include at least one of a recipient identification or a sender priority. In some implementations, when a communication is urgent then an interruption mode setting of the device can be overridden to break through the settings of the interruption mode to trigger a notification which would otherwise have been suppressed. In some instances, an interruption mode can be selected which includes smart interruption blocking so that unless the communication is deemed to be urgent or important, any notifications associated with the communication are blocked or delayed from being triggered at the device.

In some implementations, for example, the device may include a first operative configuration corresponding to a configuration setting to reduce frequency of notifications, where when the device is locked, the process 700 may further include that when the first communication is determined to be urgent, a notification is provided on the device including a representation of the first content of the first communication; and when the first communication is determined to not be urgent, forgo providing the notification on the device. In some implementations, the notification is still delivered and accessible from a notification screen, however, based on the first operative configuration to reduce a frequency of notifications, the notification may be omitted from the lock screen of the device and may not trigger an interruption, such as an audible signal or vibratory signal on the device. In such instances, for example, when the user unlocks the device, the notification may be obtainable after the device is unlocked but before the user navigates away from the (now unlocked) lock screen or may be obtainable from a listing of notifications elsewhere available on the device, such as from a notification listing area of the device.

In another implementation, the device may include a user-specified operating configuration of the device. Such an operating configuration can include a configuration option that overrides interruption settings of the operating configuration when an urgent notification is determined. Thus, when the first communication is determined to be urgent, a notification can be generated and triggered on the device which overrides the setting in the operating configuration, where the notification indicates the first communication.

As described above, one aspect of the present technology is the gathering and use of data available from specific and legitimate sources for providing images for selection by a user obtained via electronic devices. The present disclosure contemplates that in some instances, this gathered data may include personal information data that uniquely identifies or can be used to identify a specific person. Such personal information data can include voice data, demographic data, location-based data, online identifiers, telephone numbers, email addresses, home addresses, data or records relating to a user's health or level of fitness (e.g., vital signs measurements, medication information, exercise information), date of birth, or any other personal information.

The present disclosure recognizes that the use of such personal information data, in the present technology, can be used to the benefit of users. For example, the personal information data can be used for providing user selected, user provided, and/or user controlled images to another based on inputs from the user. Accordingly, use of such personal information data may facilitate transactions (e.g., on-line transactions).

The present disclosure contemplates that those entities responsible for the collection, analysis, disclosure, transfer, storage, or other use of such personal information data will comply with well-established privacy policies and/or privacy practices. In particular, such entities would be expected to implement and consistently apply privacy practices that are generally recognized as meeting or exceeding industry or governmental requirements for maintaining the privacy of users. Such information regarding the use of personal data should be prominently and easily accessible by users, and should be updated as the collection and/or use of data changes. Personal information from users should be collected for legitimate uses only. Further, such collection/sharing should occur only after receiving the consent of the users or other legitimate basis specified in applicable law. Additionally, such entities should consider taking any needed steps for safeguarding and securing access to such personal information data and ensuring that others with access to the personal information data adhere to their privacy policies and procedures. Further, such entities can subject themselves to evaluation by third parties to certify their adherence to widely accepted privacy policies and practices. In addition, policies and practices should be adapted for the particular types of personal information data being collected and/or accessed and adapted to applicable laws and standards, including jurisdiction-specific considerations which may serve to impose a higher standard.

Despite the foregoing, the present disclosure also contemplates embodiments in which users selectively block the use of, or access to, personal information data. That is, the present disclosure contemplates that hardware and/or software elements can be provided to prevent or block access to such personal information data. For example, in the case of operating an electronic device to provide user supplied images or annotations, the present technology can be configured to allow users to select to “opt in” or “opt out” of participation in the collection of personal information data during access to user-controlled photo libraries or inputs. In addition to providing “opt in” and “opt out” options, the present disclosure contemplates providing notifications relating to the access or use of personal information. For instance, a user may be notified upon downloading an app that their personal information data will be accessed and then reminded again just before personal information data is accessed by the app.

Moreover, it is the intent of the present disclosure that personal information data should be managed and handled in a way to minimize risks of unintentional or unauthorized access or use. Risk can be minimized by limiting the collection of data and deleting data once it is no longer needed. In addition, and when applicable, including in certain health related applications, data de-identification can be used to protect a user's privacy. De-identification may be facilitated, when appropriate, by removing identifiers, controlling the amount or specificity of data stored (e.g., collecting location data at city level rather than at an address level), controlling how data is stored (e.g., aggregating data across users), and/or other methods such as differential privacy.

Therefore, although the present disclosure broadly covers use of personal information data to implement one or more various disclosed embodiments, the present disclosure also contemplates that the various embodiments can also be implemented without the need for accessing such personal information data. That is, the various embodiments of the present technology are not rendered inoperable due to the lack of all or a portion of such personal information data.

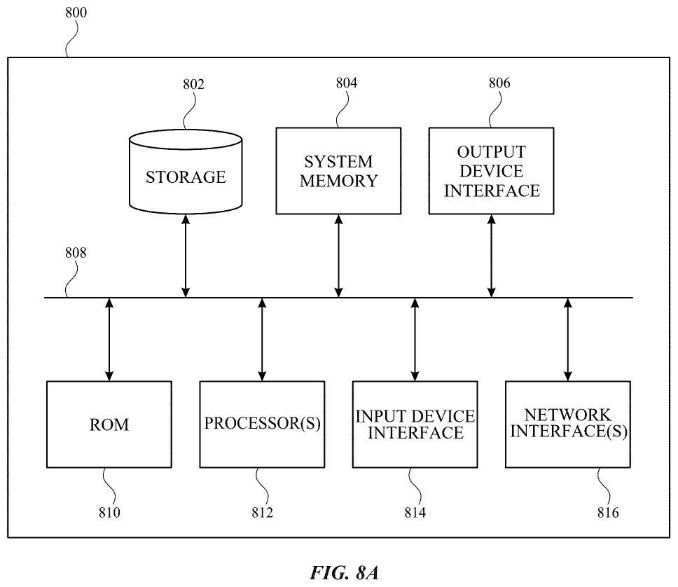

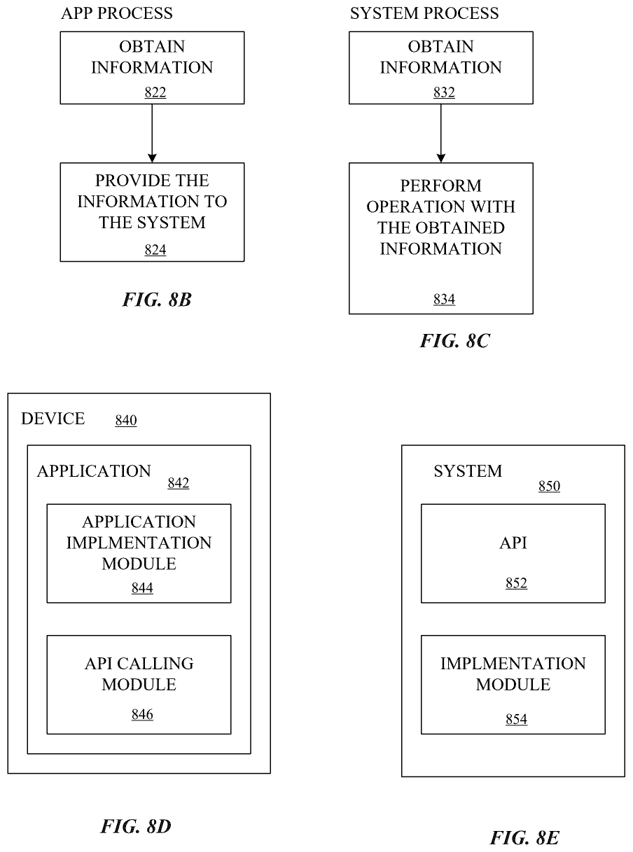

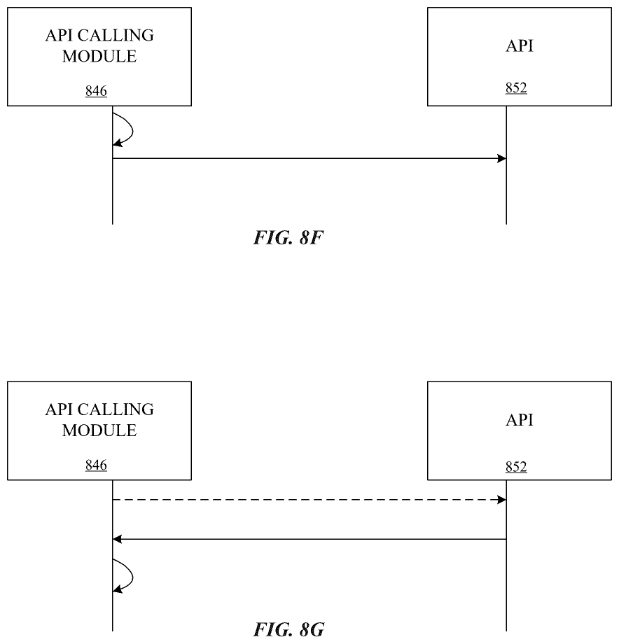

FIG. 8A illustrates an electronic system 800 with which one or more implementations of the subject technology may be implemented. The electronic system 800 can be, and/or can be a part of, one or more of the electronic devices 110, 115, and/or 120. The electronic system 800 may include various types of computer readable media and interfaces for various other types of computer readable media. The electronic system 800 includes a bus 808, one or more processing unit(s) 812, a system memory 804 (and/or buffer), a ROM 810, a permanent storage device 802, an input device interface 814, an output device interface 806, and one or more network interfaces 816, or subsets and variations thereof.

The bus 808 collectively represents all system, peripheral, and chipset buses that communicatively connect the numerous internal devices of the electronic system 800. In one or more implementations, the bus 808 communicatively connects the one or more processing unit(s) 812 with the ROM 810, the system memory 804, and the permanent storage device 802. From these various memory units, the one or more processing unit(s) 812 retrieves instructions to execute and data to process in order to execute the processes of the subject disclosure. The one or more processing unit(s) 812 can be a single processor or a multi-core processor in different implementations.

The ROM 810 stores static data and instructions that are needed by the one or more processing unit(s) 812 and other modules of the electronic system 800. The permanent storage device 802, on the other hand, may be a read-and-write memory device. The permanent storage device 802 may be a non-volatile memory unit that stores instructions and data even when the electronic system 800 is off. In one or more implementations, a mass-storage device (such as a magnetic or optical disk and its corresponding disk drive) may be used as the permanent storage device 802.

In one or more implementations, a removable storage device (such as a flash drive) may be used as the permanent storage device 802. Like the permanent storage device 802, the system memory 804 may be a read-and-write memory device. However, unlike the permanent storage device 802, the system memory 804 may be a volatile read-and-write memory, such as random access memory. The system memory 804 may store any of the instructions and data that one or more processing unit(s) 812 may need at runtime. In one or more implementations, the processes of the subject disclosure are stored in the system memory 804, the permanent storage device 802, and/or the ROM 810. From these various memory units, the one or more processing unit(s) 812 retrieves instructions to execute and data to process in order to execute the processes of one or more implementations.

The bus 808 also connects to the input and output device interfaces 814 and 806. The input device interface 814 enables a user to communicate information and select commands to the electronic system 800. Input devices that may be used with the input device interface 814 may include, for example, alphanumeric keyboards and pointing devices (also called “cursor control devices”). The output device interface 806 may enable, for example, the display of images generated by electronic system 800. Output devices that may be used with the output device interface 806 may include, for example, printers and display devices, such as a liquid crystal display (LCD), a light emitting diode (LED) display, an organic light emitting diode (OLED) display, a flexible display, a flat panel display, a solid state display, a projector, or any other device for outputting information. One or more implementations may include devices that function as both input and output devices, such as a touchscreen. In these implementations, feedback provided to the user can be any form of sensory feedback, such as visual feedback, auditory feedback, or tactile feedback; and input from the user can be received in any form, including acoustic, speech, or tactile input.

Finally, as shown in FIG. 8A, the bus 808 also couples the electronic system 800 to one or more networks and/or to one or more network nodes, through the one or more network interface(s) 816. In this manner, the electronic system 800 can be a part of a network of computers (such as a LAN, a wide area network (“WAN”), or an Intranet, or a network of networks, such as the Internet. Any or all components of the electronic system 800 can be used in conjunction with the subject disclosure.

Implementations within the scope of the present disclosure can be partially or entirely realized using a tangible computer-readable storage medium (or multiple tangible computer-readable storage media of one or more types) encoding one or more instructions. The tangible computer-readable storage medium also can be non-transitory in nature.

The computer-readable storage medium can be any storage medium that can be read, written, or otherwise accessed by a general purpose or special purpose computing device, including any processing electronics and/or processing circuitry capable of executing instructions. For example, without limitation, the computer-readable medium can include any volatile semiconductor memory, such as RAM, DRAM, SRAM, T-RAM, Z-RAM, and TTRAM. The computer-readable medium also can include any non-volatile semiconductor memory, such as ROM, PROM, EPROM, EEPROM, NVRAM, flash, nvSRAM, FeRAM, FeTRAM, MRAM, PRAM, CBRAM, SONOS, RRAM, NRAM, racetrack memory, FJG, and Millipede memory.

Further, the computer-readable storage medium can include any non-semiconductor memory, such as optical disk storage, magnetic disk storage, magnetic tape, other magnetic storage devices, or any other medium capable of storing one or more instructions. In one or more implementations, the tangible computer-readable storage medium can be directly coupled to a computing device, while in other implementations, the tangible computer-readable storage medium can be indirectly coupled to a computing device, e.g., via one or more wired connections, one or more wireless connections, or any combination thereof.

Instructions can be directly executable or can be used to develop executable instructions. For example, instructions can be realized as executable or non-executable machine code or as instructions in a high-level language that can be compiled to produce executable or non-executable machine code. Further, instructions also can be realized as or can include data. Computer-executable instructions also can be organized in any format, including routines, subroutines, programs, data structures, objects, modules, applications, applets, functions, etc. As recognized by those of skill in the art, details including, but not limited to, the number, structure, sequence, and organization of instructions can vary significantly without varying the underlying logic, function, processing, and output.

While the above discussion primarily refers to microprocessor or multi-core processors that execute software, one or more implementations are performed by one or more integrated circuits, such as ASICs or FPGAs. In one or more implementations, such integrated circuits execute instructions that are stored on the circuit itself.

Instructions can be directly executable or can be used to develop executable instructions. For example, instructions can be realized as executable or non-executable machine code or as instructions in a high-level language that can be compiled to produce executable or non-executable machine code. Further, instructions also can be realized as or can include data. Computer-executable instructions also can be organized in any format, including routines, subroutines, programs, data structures, objects, modules, applications, applets, functions, etc. As recognized by those of skill in the art, details including, but not limited to, the number, structure, sequence, and organization of instructions can vary significantly without varying the underlying logic, function, processing, and output.

While the above discussion primarily refers to microprocessor or multi-core processors that execute software, one or more implementations are performed by one or more integrated circuits, such as ASICs or FPGAs. In one or more implementations, such integrated circuits execute instructions that are stored on the circuit itself.

It is well understood that the use of personally identifiable information should follow privacy policies and practices that are generally recognized as meeting or exceeding industry or governmental requirements for maintaining the privacy of users. In particular, personally identifiable information data should be managed and handled so as to minimize risks of unintentional or unauthorized access or use, and the nature of authorized use should be clearly indicated to users.

Implementations within the scope of the present disclosure can be partially or entirely realized using a tangible computer-readable storage medium (or multiple tangible computer-readable storage media of one or more types) encoding one or more computer-readable instructions. It should be recognized that computer-executable instructions can be organized in any format, including applications, widgets, processes, software, software modules and/or components.

Implementations within the scope of the present disclosure include a computer-readable storage medium that encodes instructions organized as an application (e.g., application 842) that, when executed by one or more processing units, control device 840) to perform the method of FIG. 8B, the method of FIG. 8C, and/or one or more other processes and/or methods described herein.

It should be recognized that application 842 (shown in FIG. 8D) can be any suitable type of application, including, for example, one or more of: a browser application, an application that functions as an execution environment for plug-ins, widgets or other applications, a fitness application, a health application, a digital payments application, a media application, a social network application, a messaging application, and/or a maps application. In some embodiments, application 842 is an application that is pre-installed on device 840 at purchase (e.g., a first party application). In other embodiments, application 842 is an application that is provided to device 840 via an operating system update file (e.g., a first party application or a second party application). In some embodiments, application 842 is an application that is provided via an application store. In some embodiments, the application store can be an application store that is pre-installed on device 840 at purchase (e.g., a first party application store). In some embodiments, the application store is a third-party application store (e.g., an application store that is provided by another application store, downloaded via a network, and/or read from a storage device).

Referring to FIG. 8B and FIG. 8F, application 842 obtains information (e.g., 822). In some embodiments, at 822, information is obtained from at least one hardware component of the device 840. In some embodiments, at 822, information is obtained from at least one software module (e.g., set of instructions) of the device 840. In some embodiments, at 822, information is obtained from at least one hardware component external to the device 840 (e.g., a peripheral device, an accessory device, and/or a server). In some embodiments, the information obtained at 822 includes positional information, time information, notification information, user information, environment information, electronic device state information, weather information, media information, historical information, event information, hardware information, and/or motion information. In some embodiments, in response to and/or after obtaining the information at 822, application 842 provides the information to a system (e.g., 824).

In some embodiments, the system (e.g., 850 shown in FIG. 8E) is an operating system hosted on the device 840. In some embodiments, the system (e.g., 850 shown in FIG. 8E) is an external device (e.g., a server, a peripheral device, an accessory, and/or a personal computing device) that includes an operating system.

Referring to FIG. 8C and FIG. 8G, application 842 obtains information (e.g., 832). In some embodiments, the information obtained at 832 includes positional information, time information, notification information, user information, environment information, electronic device state information, weather information, media information, historical information, event information, hardware information and/or motion information. In response to and/or after obtaining the information at 832, application 842 performs an operation with the information (e.g., 834). In some embodiments, the operation performed at 834 includes: providing a notification based on the information, sending a message based on the information, displaying the information, controlling a user interface of a fitness application based on the information, controlling a user interface of a health application based on the information, controlling a focus mode based on the information, setting a reminder based on the information, adding a calendar entry based on the information, and/or calling an API of system 850 based on the information.

In some embodiments, one or more steps of the method of FIG. 8B and/or the method of FIG. 8C is performed in response to a trigger. In some embodiments, the trigger includes detection of an event, a notification received from system 850, a user input, and/or a response to a call to an API provided by system 850.

In some embodiments, the instructions of application 842, when executed, control device 840 to perform the method of FIG. 8B and/or the method of FIG. 8C by calling an application programming interface (API) (e.g., API 852) provided by system 850. In some embodiments, application 842 performs at least a portion of the method of FIG. 8B and/or the method of FIG. 8C without calling API 852.

In some embodiments, one or more steps of the method of FIG. 8B and/or the method of FIG. 8C includes calling an API (e.g., API 852) using one or more parameters defined by the API. In some embodiments, the one or more parameters include a constant, a key, a data structure, an object, an object class, a variable, a data type, a pointer, an array, a list or a pointer to a function or method, and/or another way to reference a data or other item to be passed via the API.

Referring to FIG. 8D, device 840 is illustrated. In some embodiments, device 840 is a personal computing device, a smartphone, a smartwatch, a fitness tracker, a head mounted display (HMD) device, a media device, a communal device, a speaker, a television, and/or a tablet. Device 840 includes application 842 and an operating system (not shown) (e.g., system 850 shown in FIG. 8E). Application 842 includes application implementation instructions 844 and API calling instructions 846. System 850 includes API 852 and implementation instructions 854. It should be recognized that device 840, application 842, and/or system 850 can include more, fewer, and/or different components than illustrated in FIG. 8D and 8E.

In some embodiments, application implementation instructions 844 is a software module that includes a set of one or more computer-readable instructions. In some embodiments, the set of one or more instructions of instructions 844 correspond to one or more operations performed by application 842. For example, when application 842 is a messaging application, application implementation instructions 844 can include operations to receive and send messages. In some embodiments, application implementation instructions 844 communicates with API calling instructions to communicate with system 850 via API 852 (shown in FIG. 8E).

In some embodiments, API-calling instructions 846 is a software module that includes a set of one or more computer-executable instructions.

In some embodiments, implementation instructions 854 is a software module that includes a set of one or more computer-executable instructions.

In some embodiments, API 852 is a software module that includes a set of one or more computer-executable instructions. In some embodiments, API 852 provides an interface that allows a different set of instructions (e.g., API calling instructions 846) to access and/or use one or more functions, methods, procedures, data structures, classes, and/or other services provided by implementation instructions 854 of system 850. For example, API-calling instructions 846 can access a feature of implementation instructions 854 through one or more API calls or invocations (e.g., embodied by a function or a method call) exposed by API 852 and can pass data and/or control information using one or more parameters via the API calls or invocations. In some embodiments, API 852 allows application 842 to use a service provided by a Software Development Kit (SDK) library. In some embodiments, application 842 incorporates a call to a function or method provided by the SDK library and provided by API 852 or uses data types or objects defined in the SDK library and provided by API 852. In some embodiments, API-calling instructions 846 makes an API call via API 852 to access and use a feature of implementation instructions 854 that is specified by API 852. In such embodiments, implementation instructions 854 can return a value via API 852 to API-calling instructions 846 in response to the API call. The value can report to application 842 the capabilities or state of a hardware component of device 840, including those related to aspects such as input capabilities and state, output capabilities and state, processing capability, power state, storage capacity and state, and/or communications capability. In some embodiments, API 852 is implemented in part by firmware, microcode, or other low level logic that executes in part on the hardware component.

In some embodiments, API 852 allows a developer of API-calling instructions 846 (which can be a third-party developer) to leverage a feature provided by implementation instructions 854. In such embodiments, there can be one or more sets of API-calling instructions (e.g., including API-calling instructions 846) that communicate with implementation instructions 854. In some embodiments, API 852 allows multiple sets of API-calling instructions written in different programming languages to communicate with implementation instructions 854 (e.g., API 852 can include features for translating calls and returns between implementation instructions 854 and API-calling instructions 846) while API 852 is implemented in terms of a specific programming language. In some embodiments, API-calling instructions 846 calls APIs from different providers such as a set of APIs from an OS provider, another set of APIs from a plug-in provider, and/or another set of APIs from another provider (e.g., the provider of a software library) or creator of the another set of APIs.

Examples of API 852 can include one or more of: a pairing API (e.g., for establishing secure connection, e.g., with an accessory), a device detection API (e.g., for locating nearby devices, e.g., media devices and/or smartphone), a payment API, a UIKit API (e.g., for generating user interfaces), a location detection API, a locator API, a maps API, a health sensor API, a sensor API, a messaging API, a push notification API, a streaming API, a collaboration API, a video conferencing API, an application store API, an advertising services API, a web browser API (e.g., WebKit API), a vehicle API, a networking API, a WiFi API, a Bluetooth API, an NFC API, a UWB API, a fitness API, a smart home API, contact transfer API, photos API, camera API, and/or image processing API. In some embodiments the sensor API is an API for accessing data associated with a sensor of device 840. For example, the sensor API can provide access to raw sensor data. For another example, the sensor API can provide data derived (and/or generated) from the raw sensor data. In some embodiments, the sensor data includes temperature data, image data, video data, audio data, heart rate data, IMU (inertial measurement unit) data, lidar data, location data, GPS data, and/or camera data. In some embodiments, the sensor includes one or more of an accelerometer, temperature sensor, infrared sensor, optical sensor, heartrate sensor, barometer, gyroscope, proximity sensor, temperature sensor and/or biometric sensor.

In some embodiments, implementation instructions 854 is a system (e.g., operating system, server system) software module (e.g., a collection of computer-readable instructions) that is constructed to perform an operation in response to receiving an API call via API 852. In some embodiments, implementation instructions 854 is constructed to provide an API response (via API 852) as a result of processing an API call. By way of example, implementation instructions 854 and API-calling instructions 846 can each be any one of an operating system, a library, a device driver, an API, an application program, or other module. It should be understood that implementation instructions 854 and API-calling instructions 846 can be the same or different type of software module from each other. In some embodiments, implementation instructions 854 is embodied at least in part in firmware, microcode, or other hardware logic.

In some embodiments, implementation instructions 854 returns a value through API 852 in response to an API call from API-calling instructions 846. While API 852 defines the syntax and result of an API call (e.g., how to invoke the API call and what the API call does), API 852 might not reveal how implementation instructions 854 accomplishes the function specified by the API call. Various API calls are transferred via the one or more application programming interfaces between API-calling instructions 846 and implementation instructions 854. Transferring the API calls can include issuing, initiating, invoking, calling, receiving, returning, and/or responding to the function calls or messages. In other words, transferring can describe actions by either of API-calling instructions 846 or implementation instructions 854. In some embodiments, a function call or other invocation of API 852 sends and/or receives one or more parameters through a parameter list or other structure.

In some embodiments, implementation instructions 854 provides more than one API, each providing a different view of or with different aspects of functionality implemented by implementation instructions 854. For example, one API of implementation instructions 854 can provide a first set of functions and can be exposed to third party developers, and another API of implementation instructions 854 can be hidden (e.g., not exposed) and provide a subset of the first set of functions and also provide another set of functions, such as testing or debugging functions which are not in the first set of functions. In some embodiments, implementation instructions 854 calls one or more other components via an underlying API and thus be both a set of API calling instructions and a set of implementation instructions. It should be recognized that implementation instructions 854 can include additional functions, methods, classes, data structures, and/or other features that are not specified through API 852 and are not available to API calling instructions 846. It should also be recognized that API calling instructions 846 can be on the same system as implementation instructions 854 or can be located remotely and access implementation instructions 854 using API 852 over a network. In some embodiments, implementation instructions 854, API 852, and/or API-calling instructions 846 is stored in a machine-readable medium, which includes any mechanism for storing information in a form readable by a machine (e.g., a computer or other data processing system). For example, a machine-readable medium can include magnetic disks, optical disks, random access memory; read only memory, and/or flash memory devices.

In some embodiments, the process 600 and/or 700 (FIG. 6, FIG. 7) is performed at a first computer system (as described herein) via a system process (e.g., an operating system process, a server system process) that is different from one or more applications executing and/or installed on the first computer system.

In some embodiments, the process 600 and/or 700 (FIG. 6, FIG. 7) is performed at a first computer system (as described herein) by an application (e.g., a trusted application, such as one provided or verified by the manufacturer of the system) that is different from a system process. In some embodiments, the instructions of the application, when executed, control the first computer system to perform process 600 and/or 700 (FIG. 6, FIG. 7) by calling an application programming interface (API) provided by the system process. In some embodiments, the application performs at least a portion of process 600 and/or 700 without calling the API.

In some embodiments, the application can be any suitable type of application, including, for example, one or more of: a browser application, an application that functions as an execution environment for plug-ins, widgets or other applications, a fitness application, a health application, a digital payments application, a media application, a social network application, a messaging application, and/or a maps application.

In some embodiments, the application is an application that is pre-installed on the first computer system at purchase (e.g., a first party application). In some embodiments, the application is an application that is provided to the first computer system via an operating system update file (e.g., a first party application). In some embodiments, the application is an application that is provided via an application store. In some embodiments, the application store is pre-installed on the first computer system at purchase (e.g., a first party application store) and allows download of one or more applications. In some embodiments, the application store is a third-party application store (e.g., an application store that is provided by another device, downloaded via a network, and/or read from a storage device). In some embodiments, the application is a third-party application (e.g., an app that is provided by an application store, downloaded via a network, and/or read from a storage device). In some embodiments, the application controls the first computer system to perform the process 600 and/or 700 (FIG. 6, FIG. 7) by calling an application programming interface (API) provided by the system process using one or more parameters.

In some embodiments, at least one API is a software module (e.g., a collection of computer-readable instructions) that provides an interface that allows a different set of instructions (e.g., API calling instructions) to access and use one or more functions, methods, procedures, data structures, classes, and/or other services provided by a set of implementation instructions of the system process. The API can define one or more parameters that are passed between the API calling instructions and the implementation instructions.

An API that can be called, for example, can correspond to an API to provide received communications from various sources, an API to provide summaries of communications, or an API to provide notification elements to a user interface, or combinations thereof.

As described above, in some embodiments, the application controls the first computer system to perform process 600 and/or 700 (FIG. 6, FIG. 7) by calling an application programming interface (API) provided by the system process using one or more parameters.

In some embodiments, exemplary APIs provided by the system process include one or more of: a pairing API (e.g., for establishing secure connection, e.g., with an accessory), a device detection API (e.g., for locating nearby devices, e.g., media devices and/or smartphone), a payment API, a UIKit API (e.g., for generating user interfaces), a location detection API, a locator API, a maps API, a health sensor API, a sensor API, a messaging API, a push notification API, a streaming API, a collaboration API, a video conferencing API, an application store API, an advertising services API, a web browser API (e.g., WebKit API), a vehicle API, a networking API, a WiFi API, a Bluetooth API, an NFC API, a UWB API, a fitness API, a smart home API, contact transfer API, a photos API, a camera API, and/or an image processing API.

In some embodiments, the API 852 defines a first API call API calling instructions 846, wherein the definition for the first API call specifies the relevant call parameters according to those variables and elements discussed above.

In some embodiments, the API 852 defines a first API call response that can be provided to the application by API calling instructions 846, wherein the first API call response provides responsive communications and outputs corresponding to the processes discussed above.

In some embodiments, the set of implementation instructions is a system software module (e.g., a collection of computer-readable instructions) that is constructed to perform an operation in response to receiving an API call via the API. In some embodiments, the set of implementation instructions is constructed to provide an API response (via the API) as a result of processing an API call. In some embodiments, the set of implementation instructions is included in the device (e.g., 840) that runs the application. In some embodiments, the set of implementation instructions is included in an electronic device that is separate from the device that runs the application.

Those of skill in the art would appreciate that the various illustrative blocks, modules, elements, components, methods, and algorithms described herein may be implemented as electronic hardware, computer software, or combinations of both. To illustrate this interchangeability of hardware and software, various illustrative blocks, modules, elements, components, methods, and algorithms have been described above generally in terms of their functionality. Whether such functionality is implemented as hardware or software depends upon the particular application and design constraints imposed on the overall system. Skilled artisans may implement the described functionality in varying ways for each particular application. Various components and blocks may be arranged differently (e.g., arranged in a different order, or partitioned in a different way) all without departing from the scope of the subject technology.

Some embodiments described herein can include use of artificial intelligence and/or machine learning systems (sometimes referred to herein as the AI/ML systems). The use can include collecting, processing, labeling, organizing, analyzing, recommending and/or generating data. Entities that collect, share, and/or otherwise utilize user data should provide transparency and/or obtain user consent when collecting such data. The present disclosure recognizes that the use of the data in the AI/ML systems can be used to benefit users. For example, the data can be used to train models that can be deployed to improve performance, accuracy, and/or functionality of applications and/or services. Accordingly, the use of the data enables the AI/ML systems to adapt and/or optimize operations to provide more personalized, efficient, and/or enhanced user experiences. Such adaptation and/or optimization can include tailoring content, recommendations, and/or interactions to individual users, as well as streamlining processes, and/or enabling more intuitive interfaces. Further beneficial uses of the data in the AI/ML systems are also contemplated by the present disclosure.

The present disclosure contemplates that, in some embodiments, data used by AI/ML systems includes publicly available data. To protect user privacy, data may be anonymized, aggregated, and/or otherwise processed to remove or to the degree possible limit any individual identification. As discussed herein, entities that collect, share, and/or otherwise utilize such data should obtain user consent prior to and/or provide transparency when collecting such data. Furthermore, the present disclosure contemplates that the entities responsible for the use of data, including, but not limited to data used in association with AI/ML systems, should attempt to comply with well-established privacy policies and/or privacy practices.

For example, such entities may implement and consistently follow policies and practices recognized as meeting or exceeding industry standards and regulatory requirements for developing and/or training AI/ML systems. In doing so, attempts should be made to ensure all intellectual property rights and privacy considerations are maintained. Training should include practices safeguarding training data, such as personal information, through sufficient protections against misuse or exploitation. Such policies and practices should cover all stages of the AI/ML systems development, training, and use, including data collection, data preparation, model training, model evaluation, model deployment, and ongoing monitoring and maintenance. Transparency and accountability should be maintained throughout. Such policies should be easily accessible by users and should be updated as the collection and/or use of data changes. User data should be collected for legitimate and reasonable uses of the entity and not shared or sold outside of those legitimate uses. Further, such collection and sharing should occur through transparency with users and/or after receiving the informed consent of the users. Additionally, such entities should consider taking any needed steps for safeguarding and securing access to such data and ensuring that others with access to the data adhere to their privacy policies and procedures. Further, such entities should subject themselves to evaluation by third parties to certify, as appropriate for transparency purposes, their adherence to widely accepted privacy policies and practices. In addition, policies and/or practices should be adapted to the particular type of data being collected and/or accessed and tailored to a specific use case and applicable laws and standards, including jurisdiction-specific considerations.

In some embodiments, AI/ML systems may utilize models that may be trained (e.g., supervised learning or unsupervised learning) using various training data, including data collected using a user device. Such use of user-collected data may be limited to operations on the user device. For example, the training of the model can be done locally on the user device so no part of the data is sent to another device. In other implementations, the training of the model can be performed using one or more other devices (e.g., server(s)) in addition to the user device but done in a privacy preserving manner, e.g., via multi-party computation as may be done cryptographically by secret sharing data or other means so that the user data is not leaked to the other devices.

In some embodiments, the trained model can be centrally stored on the user device or stored on multiple devices, e.g., as in federated learning. Such decentralized storage can similarly be done in a privacy preserving manner, e.g., via cryptographic operations where each piece of data is broken into shards such that no device alone (i.e., only collectively with another device(s)) or only the user device can reassemble or use the data. In this manner, a pattern of behavior of the user or the device may not be leaked, while taking advantage of increased computational resources of the other devices to train and execute the ML model. Accordingly, user-collected data can be protected. In some implementations, data from multiple devices can be combined in a privacy-preserving manner to train an ML model.

In some embodiments, the present disclosure contemplates that data used for AI/ML systems may be kept strictly separated from platforms where the AI/ML systems are deployed and/or used to interact with users and/or process data. In such embodiments, data used for offline training of the AI/ML systems may be maintained in secured datastores with restricted access and/or not be retained beyond the duration necessary for training purposes. In some embodiments, the AI/ML systems may utilize a local memory cache to store data temporarily during a user session. The local memory cache may be used to improve performance of the AI/ML systems. However, to protect user privacy, data stored in the local memory cache may be erased after the user session is completed. Any temporary caches of data used for online learning or inference may be promptly erased after processing. All data collection, transfer, and/or storage should use industry-standard encryption and/or secure communication.

In some embodiments, as noted above, techniques such as federated learning, differential privacy, secure hardware components, homomorphic encryption, and/or multi-party computation among other techniques may be utilized to further protect personal information data during training and/or use of the AI/ML systems. The AI/ML systems should be monitored for changes in underlying data distribution such as concept drift or data skew that can degrade performance of the AI/ML systems over time.

In some embodiments, the AI/ML systems are trained using a combination of offline and online training. Offline training can use curated datasets to establish baseline model performance, while online training can allow the AI/ML systems to continually adapt and/or improve. The present disclosure recognizes the importance of maintaining strict data governance practices throughout this process to ensure user privacy is protected.

In some embodiments, the AI/ML systems may be designed with safeguards to maintain adherence to originally intended purposes, even as the AI/ML systems adapt based on new data. Any significant changes in data collection and/or applications of an AI/ML system use may (and in some cases should) be transparently communicated to affected stakeholders and/or include obtaining user consent with respect to changes in how user data is collected and/or utilized.

Despite the foregoing, the present disclosure also contemplates embodiments in which users selectively restrict and/or block the use of and/or access to data. That is, the present disclosure contemplates that hardware and/or software elements can be provided to prevent or block access to data. For example, in the case of some services, the present technology should be configured to allow users to select to “opt in” or “opt out” of participation in the collection of data during registration for services or anytime thereafter. In another example, the present technology should be configured to allow users to select not to provide certain data for training the AI/ML systems and/or for use as input during the inference stage of such systems. In yet another example, the present technology should be configured to allow users to be able to select to limit the length of time data is maintained or entirely prohibit the use of their data for use by the AI/ML systems. In addition to providing “opt in” and “opt out” options, the present disclosure contemplates providing notifications relating to the access or use of personal information. For instance, a user can be notified when their data is being input into the AI/ML systems for training or inference purposes, and/or reminded when the AI/ML systems generate outputs or make decisions based on their data.

The present disclosure recognizes AI/ML systems should incorporate explicit restrictions and/or oversight to mitigate against risks that may be present even when such systems have been designed, developed, and/or operated according to industry best practices and standards. For example, outputs may be produced that could be considered erroneous, harmful, offensive, and/or biased; such outputs may not necessarily reflect the opinions or positions of the entities developing or deploying these systems. Furthermore, in some cases, references to third-party products and/or services in the outputs should not be construed as endorsements or affiliations by the entities providing the AI/ML systems. Generated content can be filtered for potentially inappropriate or dangerous material prior to being presented to users, while human oversight and/or ability to override or correct erroneous or undesirable outputs can be maintained as a failsafe.

The present disclosure further contemplates that users of the AI/ML systems should refrain from using the services in any manner that infringes upon, misappropriates, or violates the rights of any party. Furthermore, the AI/ML systems should not be used for any unlawful or illegal activity, nor to develop any application or use case that would commit or facilitate the commission of a crime, or other tortious, unlawful, or illegal act. The AI/ML systems should not violate, misappropriate, or infringe any copyrights, trademarks, rights of privacy and publicity, trade secrets, patents, or other proprietary or legal rights of any party, and appropriately attribute content as required. Further, the AI/ML systems should not interfere with any security, digital signing, digital rights management, content protection, verification, or authentication mechanisms. The AI/ML systems should not misrepresent machine-generated outputs as being human-generated.

It is understood that any specific order or hierarchy of blocks in the processes disclosed is an illustration of example approaches. Based upon design preferences, it is understood that the specific order or hierarchy of blocks in the processes may be rearranged, or that all illustrated blocks be performed. Any of the blocks may be performed simultaneously. In one or more implementations, multitasking and parallel processing may be advantageous. Moreover, the separation of various system components in the implementations described above should not be understood as requiring such separation in all implementations, and it should be understood that the described program components and systems can generally be integrated together in a single software product or packaged into multiple software products.

As used in this specification and any claims of this application, the terms “base station”, “receiver”, “computer”, “server”, “processor”, and “memory” all refer to electronic or other technological devices. These terms exclude people or groups of people. For the purposes of the specification, the terms “display” or “displaying” means displaying on an electronic device.

As used herein, the phrase “at least one of” preceding a series of items, with the term “and” or “or” to separate any of the items, modifies the list as a whole, rather than each member of the list (i.e., each item). The phrase “at least one of” does not require selection of at least one of each item listed; rather, the phrase allows a meaning that includes at least one of any one of the items, and/or at least one of any combination of the items, and/or at least one of each of the items. By way of example, the phrases “at least one of A, B, and C” or “at least one of A, B, or C” each refer to only A, only B, or only C; any combination of A, B, and C; and/or at least one of each of A, B, and C.

The predicate words “configured to”, “operable to”, and “programmed to” do not imply any particular tangible or intangible modification of a subject, but, rather, are intended to be used interchangeably. In one or more implementations, a processor configured to monitor and control an operation or a component may also mean the processor being programmed to monitor and control the operation or the processor being operable to monitor and control the operation. Likewise, a processor configured to execute code can be construed as a processor programmed to execute code or operable to execute code.

Phrases such as an aspect, the aspect, another aspect, some aspects, one or more aspects, an implementation, the implementation, another implementation, some implementations, one or more implementations, an embodiment, the embodiment, another embodiment, some implementations, one or more implementations, a configuration, the configuration, another configuration, some configurations, one or more configurations, the subject technology, the disclosure, the present disclosure, other variations thereof and alike are for convenience and do not imply that a disclosure relating to such phrase(s) is essential to the subject technology or that such disclosure applies to all configurations of the subject technology. A disclosure relating to such phrase(s) may apply to all configurations, or one or more configurations. A disclosure relating to such phrase(s) may provide one or more examples. A phrase such as an aspect or some aspects may refer to one or more aspects and vice versa, and this applies similarly to other foregoing phrases.

The word “exemplary” is used herein to mean “serving as an example, instance, or illustration”. Any embodiment described herein as “exemplary” or as an “example” is not necessarily to be construed as preferred or advantageous over other implementations. Furthermore, to the extent that the term “include”, “have”, or the like is used in the description or the claims, such term is intended to be inclusive in a manner similar to the term “comprise” as “comprise” is interpreted when employed as a transitional word in a claim.

All structural and functional equivalents to the elements of the various aspects described throughout this disclosure that are known or later come to be known to those of ordinary skill in the art are expressly incorporated herein by reference and are intended to be encompassed by the claims. Moreover, nothing disclosed herein is intended to be dedicated to the public regardless of whether such disclosure is explicitly recited in the claims. No claim element is to be construed under the provisions of 35 U.S.C. § 112(f) unless the element is expressly recited using the phrase “means for” or, in the case of a method claim, the element is recited using the phrase “step for”.

The previous description is provided to enable any person skilled in the art to practice the various aspects described herein. Various modifications to these aspects will be readily apparent to those skilled in the art, and the generic principles defined herein may be applied to other aspects. Thus, the claims are not intended to be limited to the aspects shown herein, but are to be accorded the full scope consistent with the language claims, wherein reference to an element in the singular is not intended to mean “one and only one” unless specifically so stated, but rather “one or more”. Unless specifically stated otherwise, the term “some” refers to one or more. Pronouns in the masculine (e.g., his) include the feminine and neuter gender (e.g., her and its) and vice versa. Headings and subheadings, if any, are used for convenience only and do not limit the subject disclosure.

What is claimed is:

1. A method comprising:
receiving, at a device, a first communication associated with a first application of a plurality of applications, the first communication comprising first content;
receiving, at the device, a second communication associated with at least one of the plurality of applications, the second communication comprising second content;
determining that a content summarization event for at least one of the plurality of applications has occurred;
responsive to determining that the content summarization event has occurred, generating a summary of the first and second content, the summary comprising third content that is separate from the first and second content; and
providing the summary for display to a user.

2. The method of claim 1, wherein the content summarization event occurs based on at least one of: a user request for the summary, an amount of time elapsed from receiving the first communication without detecting that the first content was viewed by the user, or a number of received communications associated with the at least one of the plurality of applications.

3. The method of claim 1, further comprising:
providing the summary for display in the first application associated with the first and second communications.

4. The method of claim 1, further comprising:
providing the summary for display on a lock screen of the device in association with a first excerpt of the first communication and a second excerpt of the second communication.

5. The method of claim 4, wherein the third content of the summary is distinct from the first and second excerpts.

6. The method of claim 4, wherein the summary is displayed in a first graphical element, the first excerpt is displayed in a second graphical element, and the second excerpt is displayed in a third graphical element, where the first, second and third graphical elements are displayed in a stack with the first graphical element being displayed as a top of the stack.

7. The method of claim 1, wherein the generating the summary comprises providing the first content, the second content, and parameters as a prompt to an automatic summary generating process and receiving the summary according to the prompt provided to the automatic summary generating process.

8. The method of claim 7, further comprising:
determining that the summary satisfies the parameters supplied to the automatic summary generating process.

9. The method of claim 1, further comprising:
while the device is locked, receiving one or more additional communications corresponding to the at least one of the plurality of applications; and
updating the summary based on the one or more additional communications, wherein the summary is provided on a lock screen of the device or in the corresponding first application.

10. The method of claim 1, wherein the method further comprises:
receiving a third communication related to a second application, wherein the third communication is similar to at least one of the first communication or the second communication;
determining the similarity of the first communication, the second communication, and the third communication; and
forgo generating a second summary based on the third communication.

11. The method of claim 1, further comprising:
generating a second summary of third content associated with a third communication, wherein the third communication is associated with the at least one of the plurality of applications; and
providing the second summary for display to the user, the second summary including a summary of the first content, the second content, and the third content.

12. A method comprising:
receiving, at a device, a first communication associated with a first application of the device, the first communication comprising a first body of text and metadata;
analyzing the first body of text and determining whether the first communication is urgent based, at least in part, on the first body of text and independently of the metadata; and
providing at least a portion of the first body of text of the first communication to the device, wherein when the first communication is determined to be urgent, the providing includes an indication that the first communication is urgent.

13. The method of claim 12, wherein the metadata includes at least one of a recipient identification of a sender priority.

14. The method of claim 12, wherein the indication that the first communication is urgent includes a placement of a representation of the first communication in a designated portion of a display.

15. The method of claim 14, wherein the designated portion of the display comprises a lock screen of the device or a banner notification area of the device.

16. The method of claim 14, wherein the designated portion of the display comprises a messages application or an email application of the device.

17. The method of claim 12, wherein the device comprises a first operative configuration corresponding to a configuration setting to reduce frequency of notifications, wherein when the device is locked the method further comprises:
when the first communication is determined to be urgent, providing a notification on the device including a representation of the first body of text; and
when the first communication is determined to not be urgent, forgo providing the notification on the device.

18. The method of claim 17, further comprising:
receiving, at the device, a second communication corresponding to the first application of the device;
generating a summary of the first body of text of the first communication and the second communication; and
when the second communication is determined to not be urgent, providing the summary at the device, the summary including a content other than a first excerpt of the first body of text and another content other than a second excerpt of the second communication.

19. The method of claim 12, wherein the device comprises an operating configuration comprising a configuration option that overrides interruption settings of the operating configuration when an urgent notification is determined, the method further comprising:
when the first communication is determined to be urgent, triggering, on the device, a notification overriding the interruption setting in the operating configuration, the notification indicating the first communication.

20. A computer readable medium storing instructions of an application for controlling an electronic device to perform a method, the method comprising:
obtaining first information based on a communication input, the communication input corresponding to an input received from a notification handler, an email handler, or a messaging handler;
providing the first information based on the communication input to an operating system; and
in response to providing the first information to the operating system, receiving second information, wherein the second information is a summary of the first information based on a content analyzer.
